(19) United States
(12) Patent Application Publication
(10) Pub. No.: US 2005/0229139 A1
(43) Pub. Date: Oct. 13, 2005

(54) Block-based processing in a packet-based reconfigurable architecture

(75) Inventors: Vicki W. Tsai, Mountain View, CA (US); Inching Chen, Portland, OR (US)

Correspondence Address: LeMoine Patent Services, PLLC;c/o PortfolioIP, P.O. Box 52050, Minneapolis, MN, 55402, US

(73) Assignee: Intel Corporation

(21) Appl. No.: 10/813,461

(22) Filed: Mar. 30, 2004

(51) Int. Cl. G06F 17/50

(52) U.S. Cl. 716/17; 716/3; 716/18

(57) ABSTRACT

A configurable circuit including a heterogeneous mix of processing elements is programmed.

### FIELD

The present invention relates generally to reconfigurable circuits, and more specifically to programming reconfigurable circuits.

### BACKGROUND

Some integrated circuits are programmable or configurable. Examples include microprocessors and field programmable gate arrays. As programmable and configurable integrated circuits become more complex, the tasks of programming and configuring them also become more complex.

### BRIEF DESCRIPTION OF THE DRAWINGS

FIG. 1 shows a block diagram of a reconfigurable circuit;

FIG. 2 shows a diagram of a reconfigurable circuit design flow;

FIG. 3 shows a diagram of function-to-function data processing flow within a reconfigurable circuit;

FIG. 4 shows a packet size assignment flowchart in accordance with various embodiments of the present invention;

FIG. 5 shows a diagram of an electronic system in accordance with various embodiments of the present invention; and

FIGS. 6 and 7 show flowcharts in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual nodes within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

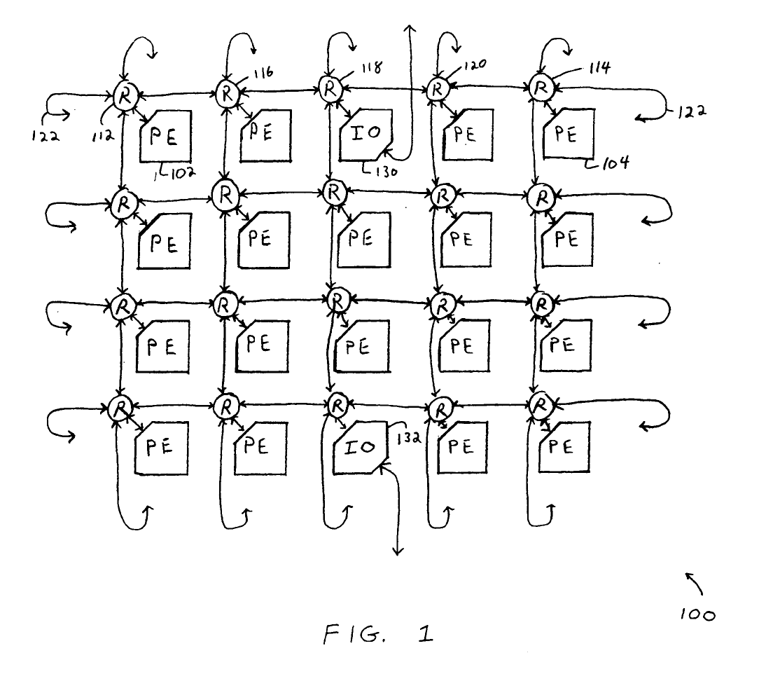

FIG. 1 shows a block diagram of a reconfigurable circuit. Reconfigurable circuit 100 includes a plurality of processing elements (PEs) and a plurality of interconnected routers (Rs). In some embodiments, each PE is coupled to a single router, and the routers are coupled together in toroidal arrangements. For example, as shown in FIG. 1, PE 102 is coupled to router 112, and PE 104 is coupled to router 114. Also for example, as shown in FIG. 1, routers 112 and 114 are coupled together through routers 116, 118, and 120, and are also coupled together directly by interconnect 122 (shown at left of R 112 and at right of R 114). The various routers (and PEs) in reconfigurable circuit 100 are arranged in rows and columns with nearest-neighbor interconnects, forming a toroidal interconnect. In some embodiments, each router is coupled to a single PE; and in other embodiments, each router is coupled to more than one PE.

In some embodiments of the present invention, configurable circuit 100 may include various types of PEs having a variety of different architectures. For example, PE 102 may include a programmable logic array that may be configured to perform a particular logic function, while PE 104 may include a processor core that may be programmed with machine instructions. In general, any number of PEs with a wide variety of architectures may be included within configurable circuit 100.

As shown in FIG. 1, configurable circuit 100 also includes input/output (IO) nodes 130 and 132. Input/output nodes 130 and 132 may be used by configurable circuit 100 to communicate with other circuits. For example, IO node 130 may be used to communicate with a host processor, and IO node 132 may be used to communicate with an analog front end such as a radio frequency (RF) receiver or transmitter. Any number of IO nodes may be included in configurable circuit 100, and their architectures may vary widely. Like PEs, IOs may be configurable, and may have differing levels of configurability based on their underlying architectures.

In some embodiments, each PE is individually configurable. For example, PE 102 may be configured by loading a table of values that defines a logic function, and PE 104 may be programmed by loading a machine program to be executed by PE 104. In some embodiments, a PE may be configured or programmed to perform multiple functions. For example, a PE may perform multiple filtering functions or multiple coding or decoding functions. In some embodiments, multiple functions may operate in parallel in a PE.

In some embodiments, various PE parameters may be modified. For example, power supply voltage values and clock frequencies for various PEs may be configurable. By modifying power supply voltages, clock frequencies, and other parameters, intelligent tradeoffs between speed, power, and other variables may be made during the design phase of a particular configuration.

The terms “configurable” and “programmable” are used herein as qualitative terms to qualitatively differentiate between different types of PEs, and are not meant to limit the invention in any way. The degree of flexibility that makes a PE configurable as opposed to programmable is chosen somewhat arbitrarily. In some embodiments, PEs fall somewhere between configurable and programmable.

In some embodiments, the routers communicate with each other and with PEs using packets of information. For example, if PE 102 has information to be sent to PE 104, it may send a packet of data to router 112, which routes the packet to router 114 for delivery to PE 104. Packets may be of any size. In embodiments that utilize packets, configurable circuit 100 may be referred to as a “packet-based reconfigurable architecture.”

A PE may be configured or programmed to perform multiple functions sequentially or in parallel. Each of the multiple functions may communicate separately with other functions on other PEs, and each of the multiple functions may utilize different types or sizes of packets. Functions and packet sizes are described further below with reference to the remaining figures.

Configurable circuit 100 may be configured by receiving configuration packets through an IO node. For example, IO node 130 may receive configuration packets that include configuration information for various PEs and IOs, and the configuration packets may be routed to the appropriate nodes. Configurable circuit 100 may also be configured by receiving configuration information through a dedicated programming interface. For example, a serial interface such as a serial scan chain may be utilized to program configurable circuit 100.

Configurable circuit 100 may have many uses. For example, configurable circuit 100 may be configured to instantiate particular physical layer (PHY) implementations in communications systems, or to instantiate particular media access control layer (MAC) implementations in communications systems. In some embodiments, multiple configurations for configurable circuit 100 may exist, and changing from one configuration to another may allow a communications system to quickly switch from one PHY to another, one MAC to another, or between any combination of multiple configurations.

In some embodiments, configurable circuit 100 is part of an integrated circuit. In some of these embodiments, configurable circuit 100 is included on an integrated circuit die that includes circuitry other than configurable circuit 100. For example, configurable circuit 100 may be included on an integrated circuit die with a processor, memory, or any other suitable circuit. In some embodiments, configurable circuit 100 coexists with radio frequency (RF) circuits on the same integrated circuit die to increase the level of integration of a communications device. Further, in some embodiments, configurable circuit 100 spans multiple integrated circuit dies.

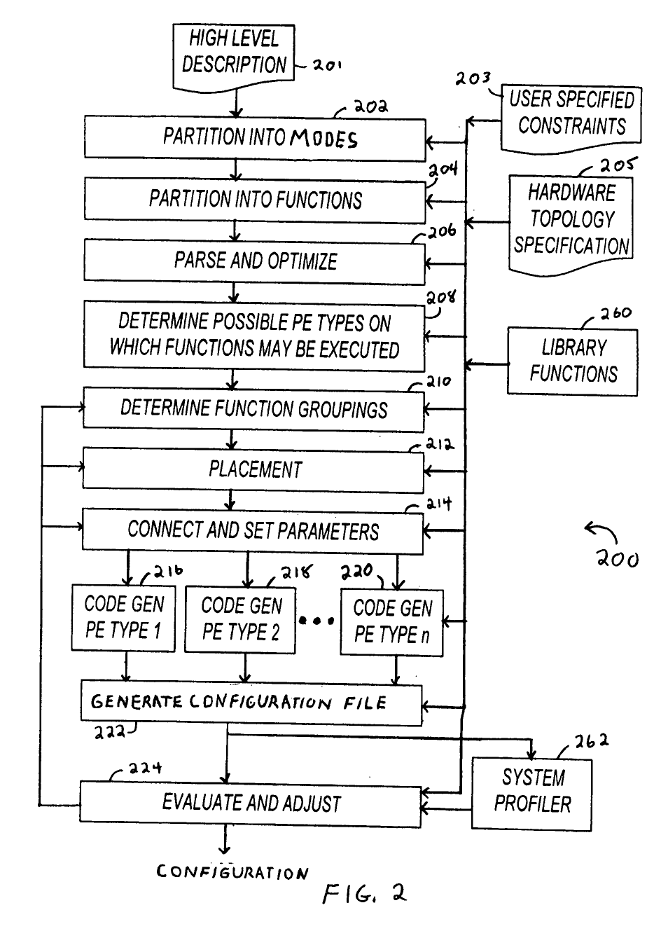

FIG. 2 shows a diagram of a reconfigurable circuit design flow. Design flow 200 represents various embodiments of design flows to process a high-level design description and create a configuration for configurable circuit 100 (FIG. 1). The various actions represented by the blocks in design flow 200 may be performed in the order presented, or may be performed in a different order. Further, in some embodiments, some blocks shown in FIG. 2 are omitted from design flow 200. Design flow 200 may accept one or more of: a high-level description 201 of a design for a configurable circuit, user-specified constraints 203, and/or a hardware topology specification 205. Hardware topology specification 205 may include information describing the number, arrangement, and types of PEs in a target configurable circuit.

High-level description 201 includes information describing the operation of the intended design. The intended design may be useful for any purpose. For example, the intended design may be useful for image processing, video processing, audio processing, or the like. The intended design is referred to herein as a “protocol,” but this terminology is not meant to limit the invention in any way. In some embodiments, the protocol specified by high-level description 201 may be in the form of an algorithm that a particular PHY, MAC, or combination thereof, is to implement. The high-level description may be in the form of a procedural or object-oriented language, such as C, C++, or hardware design language (HDL), or may be written in a specialized, or “stylized” version of a high level language.

User specified constraints 203 may include constraints such as minimum requirements that the completed configuration should meet, or may include other information to constrain the operation of the design flow. The constraints may be related to the target protocol, or they may be related to overall goals of design flow 200, such as mapping and placement. Protocol related constraints may include latency and throughput constraints. In some embodiments, various constraints are assigned weights so that they are given various amounts of deference during the operation of design flow 200. In some embodiments, constraints may be listed as requirements or preferences, and in some embodiments, constraints may be listed as ranges of parameter values. In some embodiments, constraints may not be absolute. For example, if the target reconfigurable circuit includes a data path that communicates with packets, the measured latency through part of the protocol may not be a fixed value but instead may be one with a statistical variation.

Overall mapping goals may include such constraints as low power consumption and low area usage. Any combination of the global, overall goals may be specified as part of user-specified constraints 203. Satisfying various constraints involves tuning various parameters, such as PE clock frequencies and functions' input block size and physical output packet size. These parameters and others are described more fully below.

In design flow 200, the high-level description 201 is partitioned into modes at 202 and partitioned into functions at 204. Partitioning into modes refers to breaking a protocol into non-overlapping segments in time where different processing may occur. For example, at a very high level, a wireless physical layer protocol can be broken into a transmit path and a receive path. The receive path may be further partitioned into modes such as acquisition and steady-state. Each of these modes may be partitioned into smaller modes, depending on the implementation.

Once a protocol has been partitioned into modes, the modes may be further partitioned into functions. Functions may serve data path purposes or control path purposes, or some combination of the two. Data path functions process blocks of data and send their output data to other data path functions. In some embodiments, these functions are defined using a producer-consumer model where a “producer” function produces data that is consumed by a “consumer” function. Utilizing data path functions that follow a producer-consumer model allows algorithms that are heavy in data flow to be mapped to a configurable circuit such as configurable circuit 100 (FIG. 1). Control path functions may implement sequential functions such as state machines or software running on processors. Control path functions may also exist across multiple modes to coordinate data flow.

In some embodiments, algorithms are partitioned into a hierarchical representation of stages and functions. For example, many PHY implementations include a considerable amount of pipelined processing. A hierarchical representation of a PHY may be produced by breaking down each function into other functions until the pipeline is represented by lowest level functions in the hierarchy. The functions that are at the lowest level of the hierarchy are referred to as “leaf” functions. Leaf functions represent atomic functions that are not partitioned further. In some embodiments, leaf functions are represented by a block of code written in a stylized high-level language, a block of code written in a low-level format for a specific PE type, or a library function call.

At 206 in design flow 200, the partitioned code is parsed and optimized. A parser parses the code into tokens, and performs syntactic checking followed by semantic checking. The result is a conversion into an intermediate representation (IR). Any intermediate representation format may be used.

Although optimization is shown concurrently with parsing in design flow 200, there are several points in the design flow where optimization may occur. At this point in the design flow, optimizations such as dead code removal and common expression elimination may be performed. Other PE-independent optimizations may also be performed on the intermediate representation at this point.

At 208 and 210, functions are mapped to PEs. In some embodiments, functions are grouped by selecting various functions that can execute on the same PE type. All functions are assigned to a group, and each group may include any number of functions. Each group may be assigned to a PE, or groups may be combined prior to assigning them to PEs.

In some embodiments, prior to forming groups, all possible PE mappings are enumerated for each function. The hardware topology specification 205 may be utilized to determine the types of resources available in the target reconfigurable circuit. The code in each function may then be analyzed to determine the possible PE types on which the function could successfully map. Some functions may have only one possibility, such as a library function with a single implementation. Library information may be gathered for this purpose from library 260. Other functions may have many possibilities, such as a simple arithmetic function which may be implemented on many different types of PEs. A table may be built that contains all the possibilities of each function, which may be ranked in order of likelihood. This table may be referenced throughout design flow 200.

After the table has been constructed, groups of functions may be formed. Functions that can execute on only one type of PE have limited groups to which they can belong. In some embodiments, user specified constraints 203 may specify a grouping of functions, or may specify a maximum delay or latency that may affect the successful formation of groups. In some embodiments, heuristics may be utilized in determining groupings that are likely to be successful. Information stored in the hierarchical structure created after partitioning may also be utilized.

At 212 in design flow 200, the groups are assigned, or “placed,” to particular PEs in the target configurable circuit. Several factors may guide the placement, including group placement possibilities, user constraints, and the profiler based feedback (described more fully below). Possible placement options are also constrained by information in the hardware topology specification 205. For example, to satisfy tight latency constraints, it may be useful to place two groups on PEs that are next to each other. The placement may also be guided by the directed feedback from the “evaluate and adjust” operation described below.

At 214 in design flow 200, packet routing information is generated to “connect” the various PEs. For example, producer functions are “connected” to appropriate consumer functions for the given mapping and placement. In some embodiments, the connections are performed by specifying the relative address from the PE with a producer function to the appropriate PE with a consumer function. In some cases, the output may be sent to multiple destinations, so a series of relative addresses may be specified.

At 214 of design flow 200, parameters are set. There are a number of parameters that can affect the performance of a mapped and placed protocol. In the constraints file there may be protocol related constraints, such as latency requirements, as well as overall mapping constraints, all of which may affect the setting of parameters. There are several parameters that can be adjusted to meet the specified constraints. Examples include, but are not limited to: input block size for functions, physical output packet size for functions, power supply voltage values for PEs, and PE clock frequency.

The “input block size” (i.e. number of input samples for a block processing-based function) of a function may be a variable parameter. Processing elements that include data path functions are generally “data driven,” referring to the manner in which functions operate on blocks of data. In some embodiments, various functions have a parameterizable input block size. These functions collect packets of data until the quantity of received data is equal to or greater than the input block size. The function then operates on the data in the input block. The size of this input block may be parameterizable, and it may also be subject to user constraints. In some embodiments, the input block size is chosen by analyzing such factors as the latency incurred, data throughput required, and the buffering needed in the PE.

A function's physical output packet size may also be a variable parameter. For data path functions, the “output block size” (i.e. number of output samples for a block processing-based function) may be related to the function's input block size, as well as other parameters. Regardless of the actual output block size, a PE may send out data in packets that are smaller than the output block size. The size of these smaller packets is referred to as the function's “physical output packet size,” or “physical packet size.” The physical packet size may affect the latency, router bandwidth, data throughput, and buffering by the function's PE. In some embodiments, user-specified constraints may guide the physical output packet size selection either directly or indirectly. For example, physical output packet size may be specified directly in user constraints, or the physical packet size may affected by other user constraints such as latency.

In some embodiments, a PE may implement multiple functions, and each function may have a different input block size, output block size, or physical output packet size. In some embodiments, block sizes and packet sizes may be set once, and in other embodiments, block sizes or packet sizes may be determined iteratively. These subjects are discussed further below with reference to the remaining figures.

The operating clock frequency of various PEs may also be a variable parameter. Power consumption may be reduced in a configurable circuit by reducing the clock frequency at which one or more PEs operate. In some embodiments, the clock frequency of various PEs is reduced to reduce power consumption, as long as the performance requirements are met. For example, if user constraints specify a maximum latency, the clock frequency of various PEs may be reduced as long as the latency constraint can still be met. In some embodiments, the clock frequency of various PEs may be increased to meet tight latency requirements. In some embodiments, the hardware topology file may show whether clock adjustment is available as a parameter for various PEs.

The power supply voltage of various PEs may also be a variable parameter. Power consumption may be reduced in a configurable circuit by reducing the power supply voltage at which one or more PEs operate. In some embodiments, the power supply voltage of various PEs is reduced to reduce power consumption, as long as the performance requirements are met. For example, if user constraints specify a maximum latency, the power supply voltage of various PEs may be reduced as long as the latency constraint can still be met. In some embodiments, the power supply voltage of various PEs may be increased to meet tight latency requirements. In some embodiments, the hardware topology file may show whether power supply voltage adjustment is available as a parameter for various PEs.

At 216, 218, and 220 of design flow 200, code is generated for various types of PEs. In some embodiments, different code generation tools exist for different types of PEs. For example, a PE that includes programmable logic may have code generated by a translator that translates the intermediate representation of logic equations into tables of information to configure the PE. Also for example, a PE that includes a processor or controller may have code generated by an assembler or compiler. In some embodiments, code is generated for each function, and then the code for a group of functions is generated for a PE. In other embodiments, code for a PE is generated from a group of functions in one operation. Configuration packets are generated to program the various PEs. Configuration packets may include the data to configure a particular PE, and may also include the address of the PE to be configured. In some embodiments, the address of the PE is specified as a relative address from the IO node that is used to communicate with the host.

At 222 of design flow 200, a configuration file is created. The creation of the configuration file may take into account information in the hardware topology file and the generated configuration packets. The quality of the current configuration as specified by the configuration file may be measured by the system profiler 262. In some embodiments, the system profiler 262 allows the gathering of information that may be compared against the user constraints to determine the quality of the current configuration. For example, the system profiler 262 may be utilized to determine whether the user specified latency or throughput requirements can be met given the current protocol layout. The system profiler passes the data regarding latency, throughput, and other performance results to the “evaluate and adjust” block at 226.

System profiler 262 may be a software program that emulates a configurable circuit, or may be a hardware device that accelerates profiling. In some embodiments, system profiler 262 includes a configurable circuit that is the same as the target configurable circuit. In other embodiments, system profiler 262 includes a configurable circuit that is similar to the target configurable circuit. System profiler 262 may accept the configuration packets through any kind of interface, including any type of serial or parallel interface.

At 226 of design flow 200, the current configuration is evaluated and adjusted. Data received from the system profiler may be utilized to determine whether the user specified constraints were met. Evaluation may include evaluating a cost function that takes into account many possible parameters, including the user specified constraints. Parameter adjustments may be made to change the behavior of the protocol, in an attempt to meet the specified constraints. The parameters to be adjusted are then fed back to the various operations (i.e. group, place, set parameters), and the process is repeated until the constraints are met or another stop condition is reached (e.g. maximum numbers of iterations to attempt).

A completed configuration is output from 226 when the constraints are met. In some embodiments, the completed configuration is in the form of a file that specifies the configuration of a configurable circuit such as configurable circuit 100 (FIG. 1). In some embodiments, the completed configuration is in the form of configuration packets to be loaded into a configurable circuit such as configurable circuit 100. The form taken by the completed configuration is not a limitation of the present invention.

The design flow described above with reference to FIG. 2 may be implemented in whole or in part by a computer or other electronic system. For example, in some embodiments, all of design flow 200 may be implemented within a compiler to compile protocols for configurable circuits. In other embodiments, portions of design flow 200 may be implemented in a compiler, and portions of design flow 200 may be performed by a user. For example, in some embodiments, a user may perform partitioning into modes, partitioning into functions, or both. In these embodiments, a compiler that implements the remainder of design flow 200 may receive a design description represented by the outputs of block 202 or 204 as shown in FIG. 2.

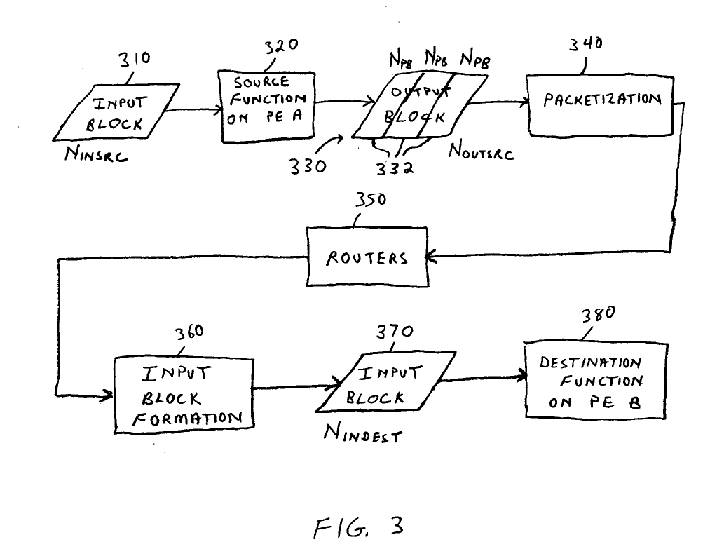

FIG. 3 shows a diagram of function-to-function data processing flow within a reconfigurable circuit. As shown in FIG. 3, a source function on one PE (shown at 320) communicates with a destination function on another PE (shown at 380). Functions represented by FIG. 3 are examples of “block-based” functions. In general, a block-based function processes a block of N_{IN} input samples and produces a block of N_{OUT} output samples. In some embodiments, block-based functions do not execute until they have sufficient input data, which, in the example of FIG. 3, is of size N_{INSRC} for source function 320 and N_{INDEST} for destination function 380.

Source function 320 processes an input block 310 of N_{INSRC} samples and produces an output block 330 of N_{OUTSRC} samples. Logically, source function 320 sends data to destination function 380 arranged in blocks of size N_{OUTSRC} samples. In some embodiments, output blocks may be broken into smaller physical units for routing between a source function and a destination function. For example, to reduce latency, data block 330 may be broken into smaller blocks 332. These smaller blocks hold N_{PB} samples. In the example of FIG. 3, output block 330 is broken into three smaller blocks, although this is not a limitation of the present invention. For example, output block 330 may be broken into more or less than three smaller blocks.

Smaller blocks 332 are “packetized” by adding overhead data (e.g. header information). The result is a “physical packet” having a size that is determined by N_{PB}. These physical packets pass through various routers (represented by routers 350) until they reach destination function 380 on PE B. The physical packets are stripped of the overhead data and combined into a block of data at 360, and input blocks of size N_{INDEST} are produced at 370. The same process shown in FIG. 3 then repeats for destination function 380.

In some embodiments, latency may be reduced by modifying the size of N_{PB} while maintaining the throughput at the source function's output. Total latency can be calculated as follows:

$$\begin{matrix}{t}_{TOTAL} = {t}_{SRC} + {t}_{ROUTE} + {t}_{DESTUNPACK} & ( 1 ) \\ {t}_{TOTAL} = ( {t}_{SRCPIPELINE} + [ {t}_{SRCBUFFER} + {t}_{SRCPROCESS} ] ) + {t}_{ROUTE} + {t}_{DESTUNPACK} & ( 2 ) \\ {t}_{TOTAL} = ( {t}_{SRCPIPELINE} + [ {f}_{1} ( {N}_{PB} ) * ceil ( \frac{{N}_{INDEST}}{{N}_{PB}} ) ] ) + {f}_{2} ( {N}_{PB} , {BW}_{USED} ) + {f}_{3} ( {N}_{PB} ) & ( 3 )\end{matrix}$$

where:
T_{TOTAL}=total latency from processing an input block of data at the source to the time when a complete input block is formed at the destination function;
T_{SRC}=latency due to the source function;
T_{SRCPIPELINE}=latency due to the pipeline of the source function;
T_{SRCBUFFER}=latency due to having buffered data at the source function;
T_{SRCPROCESS}=amount of time to process the input block of data at the source function;
T_{ROUTE}=latency due to routing the N_{PB};
T_{DESTUNPACK}=latency due to unpacking the transmitted packet and moving the data to the proper input buffer for the destination function;
N_{INDEST}=input block size required for the destination function to begin processing;
N_{PB}=physical block size into which a function's output block has been divided;
BW_{USED}=router bandwidth used to transport the data;
N_{OUTSRC}=logical output block size from the source function; and
N_{PP}=block size of the physical packet;

The total latency is thus a function of the physical packet size and the bandwidth used. In most cases, the effect of ƒ₃(N_{PB}) on the latency is negligible. For a high-speed interconnect, the ƒ₂(N_{PB}, BW_{USED}) term becomes small, so the latency is dominated by the latency due to the source:

$${t}_{TOTAL} \approx {f}_{1} ( {N}_{PB} ) * ceil ( \frac{{N}_{INDEST}}{{N}_{PB}} ) \qquad ( 4 )$$

N_{PB} can then be adjusted to reduce the total latency while still maintaining the necessary throughput. If the physical block size N_{PB} becomes too small, though, t_{RoUTE l can no longer be considered negligible.}

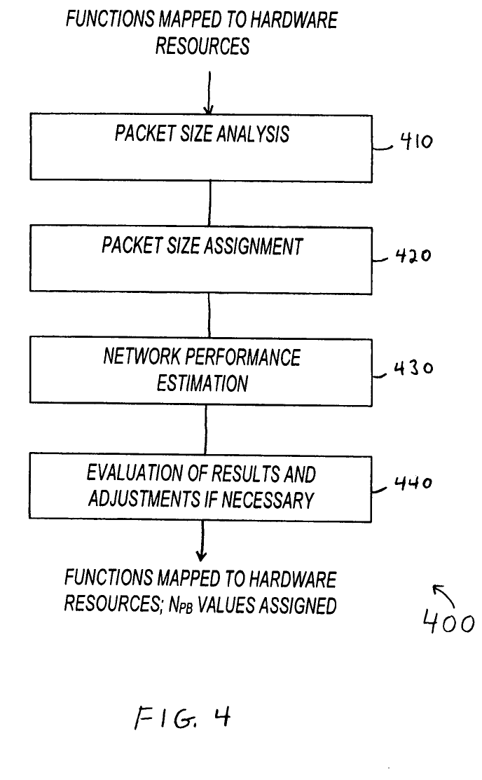

FIG. 4 shows a packet size assignment flowchart in accordance with various embodiments of the present invention. Method 400 may be performed as part of a design flow for a configurable circuit such as configurable circuit 100 (FIG. 1). For example, method 400 may be performed as part of the “connect and set parameters” block 214 in design flow 200 (FIG. 2).

Method 400 may determine a sufficient packet size for packets sent between functions to satisfy user-specified latency requirements while also guaranteeing the necessary throughput on a per function basis. Note that the packet size for different functions may vary. Packet sizes may be chosen based on function requirements, and not necessarily on the type of PE on which each function executes. Hence, multiple functions running on the same processing element hardware can each have its own output packet size independent of output packet sizes of other functions.

As shown in FIG. 4, method 400 may be performed after functions have been mapped to hardware resources within the reconfigurable architecture, although this is not a limitation of the present invention. For example, method 400 may be performed during a simulation without knowledge of the specific resources upon which the function is mapped. In these embodiments, hardware resources may be statistically modeled. Also as shown in FIG. 4, at the commencement of method 400, the connections between functions may also be known, meaning it is known to which function the output of one function should be sent.

At 410, physical packet size analysis is performed for each function that has user-specified requirements to determine an acceptable packet size that satisfies the specified latency and throughput requirements. The packet size refers to breaking the output block of data from a function into smaller blocks to reduce latency. This corresponds to breaking a function's output block into smaller blocks such as smaller blocks 332 (FIG. 3). In some embodiments, physical packet size analysis may include the analysis described above with reference to equations 1-4. At 420, a packet size is assigned for each function.

If the target reconfigurable architecture uses a packet-switched (versus a circuit-switched) interconnect, operations at 430 may be used to estimate the interaction of the algorithm's functions operating in parallel. In some embodiments, the data flow between one pair of functions may interact with data flow between another pair of functions. In these embodiments, network performance estimation may add more confidence in the packet size choices from 410.

At 440, the results of the network performance estimation may be evaluated and packet size adjustments may be made. In some embodiments, if any adjustments are needed, method 400 may iterate from 410 to 440. As shown in FIG. 4, at the end of method 400, the packet size for each function will have been assigned. If a proper packet size cannot be determined after a certain number of iterations, then the adjustment loop will end.

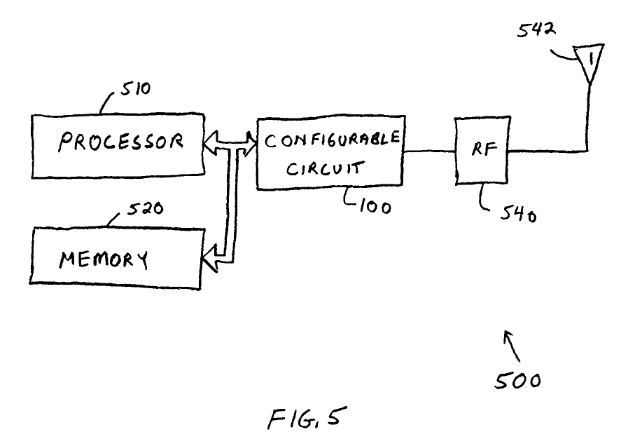

FIG. 5 shows a block diagram of an electronic system. System 500 includes processor 510, memory 520, configurable circuit 100, RF interface 540, and antenna 542. In some embodiments, system 500 may be a computer system to develop protocols for use in configurable circuit 100. For example, system 500 may be a personal computer, a workstation, a dedicated development station, or any other computing device capable of creating a configuration for configurable circuit 100. In other embodiments, system 500 may be an “end-use” system that utilizes configurable circuit 100 after it has been programmed to implement a particular protocol. Further, in some embodiments, system 500 may be a system capable of developing protocols as well as using them.

In some embodiments, processor 510 may be a processor that can perform methods implementing all of design flow 200 (FIG. 2), or portions of design flow 200. For example, processor 510 may perform function grouping, placement, mapping, profiling, and setting of parameters, or any combination thereof. Further, processor 510 may be a processor that can perform any of the method embodiments of the present invention. Processor 510 represents any type of processor, including but not limited to, a microprocessor, a microcontroller, a digital signal processor, a personal computer, a workstation, or the like.

In some embodiments, system 500 may be a communications system, and processor 510 may be a computing device that performs various tasks within the communications system. For example, system 500 may be a system that provides wireless networking capabilities to a computer. In these embodiments, processor 510 may implement all or a portion of a device driver, or may implement a lower level MAC. Also in these embodiments, configurable circuit 100 may implement one or more protocols for wireless network connectivity. In some embodiments, configurable circuit 100 may implement multiple protocols simultaneously, and in other embodiments, processor 510 may change the protocol in use by reconfiguring configurable circuit 100.

Memory 520 represents an article that includes a machine readable medium. For example, memory 520 represents any one or more of the following: a hard disk, a floppy disk, random access memory (RAM), dynamic random access memory (DRAM), static random access memory (SRAM), read only memory (ROM), flash memory, CDROM, or any other type of article that includes a medium readable by a machine such as processor 510. In some embodiments, memory 520 can store instructions for performing the execution of the various method embodiments of the present invention.

In operation of some embodiments, processor 510 reads instructions and data from memory 520 and performs actions in response thereto. For example, various method embodiments of the present invention may be performed by processor 510 while reading instructions from memory 520.

Antenna 542 may be either a directional antenna or an omni-directional antenna. For example, in some embodiments, antenna 542 may be an omni-directional antenna such as a dipole antenna, or a quarter-wave antenna. Also for example, in some embodiments, antenna 542 may be a directional antenna such as a parabolic dish antenna or a Yagi antenna. In some embodiments, antenna 542 is omitted.

In some embodiments, RF signals transmitted or received by antenna 542 may correspond to voice signals, data signals, or any combination thereof. For example, in some embodiments, configurable circuit 100 may implement a protocol for a wireless local area network interface, cellular phone interface, global positioning system (GPS) interface, or the like. In these various embodiments, RF interface 540 may operate at the appropriate frequency for the protocol implemented by configurable circuit 100. In some embodiments, RF interface 540 is omitted.

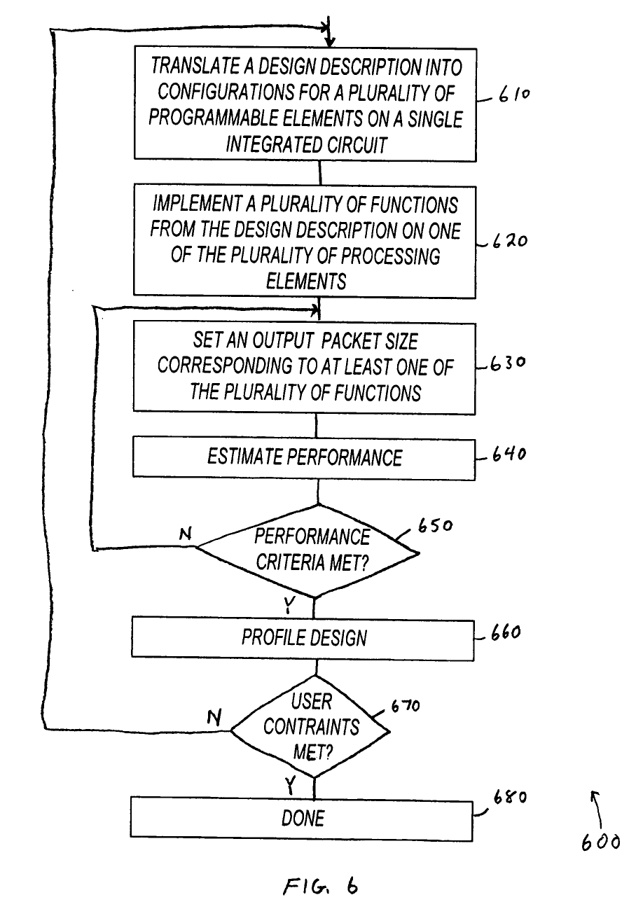

FIG. 6 shows a flowchart in accordance with various embodiments of the present invention. In some embodiments, method 600, or portions thereof, is performed by an electronic system, or an electronic system in conjunction with a person's actions. In other embodiments, all or a portion of method 600 is performed by a control circuit or processor, embodiments of which are shown in the various figures. Method 600 is not limited by the particular type of apparatus, software element, or person performing the method. The various actions in method 600 may be performed in the order presented, or may be performed in a different order. Further, in some embodiments, some actions listed in FIG. 6 are omitted from method 600.

Method 600 is shown beginning with block 610 where a design description is translated into configurations for a plurality of PEs on a single integrated circuit. For example, a design description such as that shown at 201 in FIG. 2 may be translated into configurations for PEs such as those shown in FIG. 1. Further, in some embodiments, translating a design description includes compiling functions to code to run on one or more PEs. In some embodiments, translating a design description may include many operations. For example, a design description may be in a high level language, and translating the design description may include partitioning, parsing, grouping, placement, and the like. In other embodiments, translating a design description may include few operations. For example, a design description may be represented using an intermediate representation, and translating the design description may include generating code for the various PEs.

At 620, a plurality of functions from the design description are implemented on one of the plurality of PEs. For example, during the translation of 610 or thereafter, functions in the design description may be grouped such that a PE implements one or more groups of functions. Each function implemented on a PE may be independent of the other functions on the same PE, or one or more functions implemented on a PE may be inter-related or co-dependent. Further, each of the plurality of functions implemented on a PE may have input block sizes, output block sizes, and physical output packet sizes that are independent of the other functions implemented on the PE. The actions of block 620 may be repeated for each PE in a configurable circuit, or until all functions in the design description have been implemented on PEs.

At 630, an output packet size is set. In some embodiments, the output packet size corresponds to one of the functions implemented on the PE at 620. In other embodiments, the output packet size corresponds to more than one of the functions implemented on the PE at 620. In some embodiments, independent output sizes are set for more than one of the plurality of functions, and in some embodiments, independent output packet sizes are set for each of the plurality of functions. In some embodiments, independent output packet sizes are set by dividing each function's output block size into smaller block sizes, and adding the size of packet header information. For example, referring back to FIG. 3, a function's output block 330 may be divided into smaller blocks 332.

At 640, performance is estimated using the packet size(s) set in 630. Performance estimation may include analysis to determine if certain performance requirements can be met with the chosen packet sizes for communications between functions. For example, referring back to FIG. 4, performance estimation may include the network performance estimation of block 430. Any type of performance estimation may be performed at 640. For example, latency or throughput performance on a function-by-function basis may be estimated at 640. In some embodiments, performance estimation may include determining if an output packet size may be reduced further to reduce latency without violating throughput requirements.

If performance requirements are not met, method 600 may iterate through a loop that includes blocks 630, 640, and 650. In this loop, output packet sizes may be iteratively modified on a function-by-function basis.

At 660, the design is profiled. The design referred to in 660 includes the configuration information for the various PEs. For example, referring now back to FIG. 2, the configuration file generated at 222 represents the design to be profiled. Profiling may be accomplished using one or more of many different methods. For example, a system profiler running in software may profile the design. Also for example, a target system including a configurable circuit may be employed to profile the design. The type of hardware or software used to profile the design is not a limitation of the present invention.

If user constraints are not met, method 600 may iterate through a loop that includes blocks 610, 620, 630, 640, 650, 660, and 670. In this loop, many parameters may be iteratively modified. For example, functions may be grouped differently, groups of functions may be placed differently, and function output packet sizes may be modified.

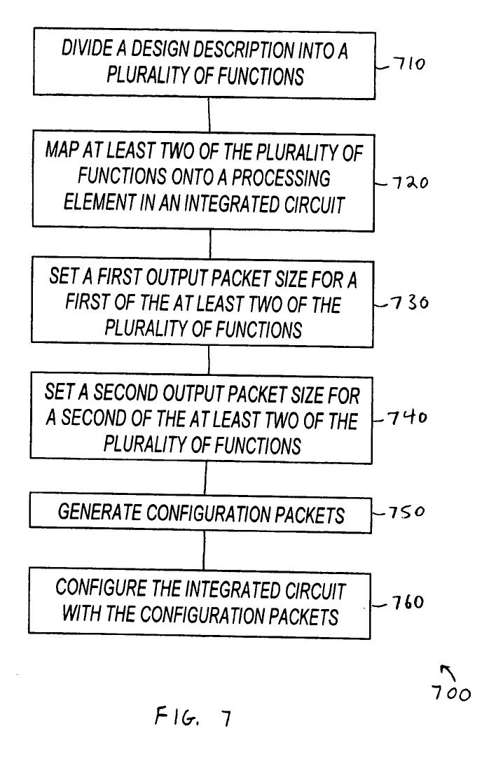

FIG. 7 shows a flowchart in accordance with various embodiments of the present invention. In some embodiments, method 700, or portions thereof, is performed by an electronic system, or an electronic system in conjunction with a person's actions. In other embodiments, all or a portion of method 700 is performed by a control circuit or processor, embodiments of which are shown in the various figures. Method 700 is not limited by the particular type of apparatus, software element, or person performing the method. The various actions in method 700 may be performed in the order presented, or may be performed in a different order. Further, in some embodiments, some actions listed in FIG. 7 are omitted from method 700.

Method 700 is shown beginning with block 710 where a design description is divided into a plurality of functions. In some embodiments, block 710 corresponds to block 204 in design flow 200. The design description may be divided into functions by a person who generates a high-level description, or the design description may be divided into functions by a machine executing all or a portion of method 700. In some embodiments, the design description may also be divided into control and data path portions when the design description is partitioned into modes and functions. For example, when the design description is divided into non-overlapping modes, such as at 202 in design flow 200, one subset of functions may represent control path portions, while another subset of functions may represent data path portions. Also for example, when the design description is divided into functions, such as at 204 in design flow 200, some functions may represent data path portions, while other functions may represent control path portions.

At 720, at least two of the plurality of functions are mapped onto a processing element (PE) in an integrated circuit. For example, multiple functions that are part of a group may be implemented on a PE within a configurable circuit such as configurable circuit 100 (FIG. 1).

At 730, a first output packet size is set for a first of the at least two of the plurality of functions, and at 740, a second output packet size is set for a second of the at least two of the plurality of functions. The functions implemented on the PE have independent output packet sizes. The first and second output packet sizes may also have independent output block sizes. In some embodiments, the packet sizes are set by dividing the output block sizes into smaller blocks.

At 750, configuration packets are generated, and at 760, the integrated circuit is configured with the configuration packets. In some embodiments, this may correspond to a system such as electronic system 500 (FIG. 5) generating packets to configure configurable circuit 100.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A method comprising:
translating a design description into configurations for a plurality of processing elements, wherein a plurality of functions in the design description are implemented on one of the plurality of processing elements; and
setting at least one output packet size corresponding to at least one of the plurality of functions.

2. The method of claim 1 wherein setting at least one output packet size comprises setting independent output packet sizes for more than one of the plurality of functions.

3. The method of claim 1 wherein setting at least one output packet size comprises setting an independent output packet size for each of the plurality of functions.

4. The method of claim 3 further comprising estimating network performance.

5. The method of claim 4 further comprising modifying the at least one output packet size and re-estimating network performance.

6. The method of claim 1 wherein translating comprises compiling the plurality of functions to code to run on the one of the plurality of processing elements.

7. The method of claim 1 wherein setting a packet size comprises dividing a function output block size into smaller physical block sizes.

8. The method of claim 7 wherein setting a packet size further includes adding a packet header size to the physical block size.

9. The method of claim 1 further comprising profiling a design represented by the configurations for the plurality of processing elements.

10. The method of claim 9 further comprising changing the at least one output packet size in response to the profiling.

11. The method of claim 9 further comprising comparing user constraints with output from the profiling.

12. The method of claim 11 wherein the user constraints include latency.

13. The method of claim 11 wherein the user constraints include throughput.

14. The method of claim 1 wherein each of the plurality of functions has an output block size, and wherein setting at least one output packet size comprises dividing the output block size to set a physical packet size.

15. The method of claim 14 wherein setting at least one output packet size further comprises estimating network performance.

16. The method of claim 15 further comprising changing the physical packet size in response to the estimating.

17. The method of claim 15 wherein profiling produces information describing throughput.

18. A method comprising:
dividing a design description into a plurality of functions;
mapping at least two of the plurality of functions onto one of a plurality of processing elements in an integrated circuit;
setting a first output packet size for a first of the at least two of the plurality of functions; and
setting a second output packet size for a second of the at least two of the plurality of functions.

19. The method of claim 18 wherein the first of the at least two of the plurality of functions has an output block size, and wherein the first output packet size is smaller than the output block size.

20. The method of claim 18 further comprising generating configuration packets to configure the integrated circuit.

21. The method of claim 20 further comprising configuring the integrated circuit with the configuration packets.

22. The method of claim 20 further comprising profiling a design with the configuration packets.

23. The method of claim 22 further comprising modifying the first output packet size in response to the profiling.

24. An apparatus including a medium to hold machine-accessible instructions that when accessed result in a machine performing:
reading a design description;
compiling the design description to configure a plurality of processing elements, wherein a plurality of functions in the design description are mapped to one of the plurality of processing elements; and
independently determining output packet sizes for each of the plurality of functions.

25. The apparatus of claim 24 wherein the machine-accessible instructions when accessed further result in the machine performing:
estimating a performance of the plurality of processing elements; and
modifying at least one of the output packet sizes in response to the estimating.

26. The apparatus of claim 25 wherein estimating a performance comprises determining if throughput constraints are met.

27. The apparatus of claim 26 wherein determining if throughput constraints are met comprises determining if throughput constraints for each of the plurality of functions are met.

28. An electronic system comprising:
a processor; and
a static random access memory to hold instructions that when accessed result in the processor performing translating a design description into configurations for a plurality of processing elements on a single integrated circuit, wherein a plurality of functions in the design description are implemented on one of the plurality of processing elements, and setting at least one output packet size corresponding to at least one of the plurality of functions.

29. The electronic system of claim 28 wherein setting at least one output packet size comprises setting independent output packet sizes for more than one of the plurality of functions.

30. The electronic system of claim 29 wherein setting at least one output packet size comprises setting an independent output packet size for each of the plurality of functions.
